(19) United States
(12) Patent Application Publication
(10) Pub. No.: US 2024/0013447 A1
(43) Pub. Date: Jan. 11, 2024

(54) METHOD AND APPARATUS ENCODING/DECODING A MULTISCALE FEATURE GROUP

(71) Applicants: Electronics and Telecommunications Research Institute, Daejeon (KR); INDUSTRY-UNIVERSITY COOPERATION FOUNDATION KOREA AEROSPACE UNIVERSITY, Goyang-si Gyeonggi-do (KR)

(72) Inventors: Joo Young LEE, Daejeon (KR); Se Yoon JEONG, Daejeon (KR); Youn Hee KIM, Daejeon (KR); Jin Soo CHOI, Daejeon (KR); Dong Ha KIM, Goyang-si Gyeonggi-do (KR); Yong Uk YOON, Goyang-si Gyeonggi-do (KR); Jae Gon KIM, Goyang-si Gyeonggi-do (KR)

(73) Assignees: Electronics and Telecommunications Research Institute, Daejeon (KR); INDUSTRY-UNIVERSITY COOPERATION FOUNDATION KOREA AEROSPACE UNIVERSITY, Goyang-si Gyeonggi-do (KR)

(21) Appl. No.: 18/350,654

(22) Filed: Jul. 11, 2023

(30) Foreign Application Priority Data
Jul. 11, 2022 (KR) 10-2022-0084978
Jul. 5, 2023 (KR) 10-2023-0087401

(51) Int. Cl. G06T 9/00; G06T 3/40

(52) U.S. Cl. CPC G06T 9/002; G06T 3/4046

(57) ABSTRACT

The present disclosure provides a method and a device for encoding/decoding a multi-scale feature group. A multi-scale feature group encoding method according to the present disclosure includes transforming a multi-scale feature group into a multi-channel feature; adjusting the number of channels of the multi-channel feature; acquiring a plane image based on a feature that the number of channels is adjusted; and encoding the plane image.

### CROSS REFERENCE TO RELATED APPLICATIONS

This application claims the priority under 35 U.S.C. § 119(a) of Korean Patent Application No. 10-2022-0084978, filed Jul. 11, 2022, and Korean Patent Application No. 10-2023-0087401, filed Jul. 5, 2023, in the Korean Intellectual Property Office, which are hereby incorporated by reference in their entireties into this application.

### TECHNICAL FIELD

The present disclosure relates to a method and a device for encoding/decoding

a multi-scale feature group.

### BACKGROUND ART

As the industrial field to which a deep neural network using deep learning is applied has expanded, a deep neural network has been increasingly applied to industrial machines. For use in applications utilizing machine-to-machine communications, a compression method which considers not only a human visual characteristic, but also a characteristic which plays an important role in a deep neural network in a machine is being actively studied.

### DISCLOSURE

### Technical Problems

The present disclosure provides a method and a device for encoding/decoding a multiscale feature group.

Specifically, the present disclosure provides a method and a device for reducing the amount of encoded data through feature arrangement, feature readjustment and feature compression.

Specifically, the present disclosure provides a method and a device for improving a specific reconstruction ability by configuring a separate processing process suitable for a feature characteristic for feature reconstruction.

Specifically, the present disclosure provides a method and a device for minimizing data lost due to compression by organically complementing each feature configuring a feature group.

Specifically, the present disclosure provides a method and a device for optimizing channel transform according to a compression rate in performing channel transform and arrangement for a feature.

Specifically, the present disclosure provides a method and a device for adaptively determining a degree of channel transform according to a compression rate.

Specifically, the present disclosure provides a method and a device for selectively compressing an important feature by arranging channels of a feature according to importance.

The technical objects to be achieved by the present disclosure are not limited to the above-described technical objects, and other technical objects which are not described herein will be clearly understood by those skilled in the pertinent art from the following description.

### Technical Solution

A method and a device for encoding a multi-scale feature group according to the present disclosure may include transforming a multi-scale feature group into a multi-channel feature, adjusting the number of channels of the multi-channel feature, acquiring a plane image based on a feature that the number of channels is adjusted and encoding the plane image.

In a method and a device for encoding a multi-scale feature group according to the present disclosure, transforming the multi-scale feature group into the multi-channel feature may include inputting features included in the multi-scale feature group to a transform network and transforming features output through the transform network according to a reference scale.

In a method and a device for encoding a multi-scale feature group according to the present disclosure, the transform network may output a feature input to the transform network by transforming it based on a higher level feature or a lower level feature.

In a method and a device for encoding a multi-scale feature group according to the present disclosure, the feature that the number of channels is adjusted may have a smaller number of channels than the multi-channel feature.

In a method and a device for encoding a multi-scale feature group according to the present disclosure, adjusting the number of channels of the multi-channel feature may include performing inter-channel readjustment for the multi-channel feature. In this case, the inter-channel readjustment may be performed based on a representative value of each channel configuring the multi-channel feature.

In a method and a device for encoding a multi-scale feature group according to the present disclosure, the representative value may be derived based on at least one of an average value, a minimum value, a maximum value or a mode value of samples for a corresponding channel.

In a method and a device for encoding a multi-scale feature group according to the present disclosure, adjusting the number of channels of the multi-channel feature may further include adjusting arrangement order of each channel according to importance of each channel.

In a method and a device for encoding a multi-scale feature group according to the present disclosure, the plane image may be acquired by packing each of channels of a feature that the number of channels is adjusted to a different space on a two-dimensional space.

In a method and a device for encoding a multi-scale feature group according to the present disclosure, the number of channels to be packed on the two-dimensional space may be determined according to importance of each of the channels.

In a method and a device for encoding a multi-scale feature group according to the present disclosure, the plane image may be partitioned into a plurality of tiles and a boundary of a tile may match an inter-channel boundary.

In a method and a device for encoding a multi-scale feature group according to the present disclosure, a quantization parameter between the tiles may be configured differently.

In a method and a device for encoding a multi-scale feature group according to the present disclosure, a quantization parameter for each of the channels may be adaptively determined according to importance of each of the channels.

A method and a device for decoding a multi-scale feature group according to the present disclosure may decode a plane image, extract a multi-channel feature from the decoded plane image, and reconstruct a multi-scale feature group from the multi-channel feature.

In a method and a device for decoding a multi-scale feature group according to the present disclosure, reconstructing the multi-scale feature group may include dividing the multi-channel feature into a plurality of features and reconstructing each of the divided features to an original resolution. In this case, reconstruction to the original resolution may be performed based on at least one of upscaling, downscaling, a convolution layer, a fully-connected layer or an activation function.

In a method and a device for decoding a multi-scale feature group according to the present disclosure, a feature in the multi-scale feature group may be reconstructed by fusing a pre-reconstructed lower level feature or a pre-reconstructed higher level feature with a feature reconstructed to the original resolution.

### Technical Effects

According to the present disclosure, encoding/decoding efficiency of a multi-scale feature group may be improved.

Specifically, according to the present disclosure, through feature arrangement, feature readjustment and feature compression, the amount of encoded data may be reduced. Specifically, according to the present disclosure, for feature reconstruction, a

specific reconstruction ability may be improved by configuring a separate processing process suitable for a feature characteristic.

Specifically, according to the present disclosure, data lost due to compression may be minimized by organically complementing each of features configuring a feature group.

Specifically, according to the present disclosure, in performing channel transform and arrangement for a feature, channel transform may be optimized according to a compression rate.

Specifically, according to the present disclosure, an effect of selectively compressing an important feature may be provided by adaptively performing a degree and arrangement of channel transform according to a compression rate.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 represents a block diagram of a machine vision network for inputting an image and/or a video.

FIG. 2 is a flow chart representing a multi-scale feature encoding/decoding method according to an embodiment of the present disclosure.

FIG. 3 shows an example of a neural network configuration in a bottom-up method in which a higher level feature is modified to include a lower level feature.

FIG. 4 shows an example of a neural network configuration in a top-down method in which a lower level feature is modified to include a higher level feature.

FIG. 5 shows a configuration example of a neural network which learns a residual for a feature.

FIG. 6 represents an example in which features are arranged when a feature with the smallest resolution is configured as a reference resolution.

FIG. 7 shows an example in which a readjusted feature group is output through a feature arrangement step and a feature channel transform step.

FIG. 8 illustrates a channel transform step in which a channel readjustment process is omitted.

FIG. 9 and FIG. 10 are a diagram for describing a learning process of a channel transform network for listing channels according to mission importance.

FIG. 11 represents an output example of a plane image acquired from a feature configured with a plurality of channels, i.e., a feature map.

FIG. 12 and FIG. 13 show an example of reconstructing each feature in a multi-scale feature group.

FIG. 14 represents another example of reconstructing a multi-scale feature group.

### BEST MODE

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims. In the present disclosure, a term such as first, second, etc. may be used to

describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

In the present disclosure, a feature refers to a content extracted from an image and/or a video. A scale (a resolution) of a feature may be expressed as at least one of (H, W), (C, H, W), (B, C, H, W). Here, C may represent the number of channels of a feature, H may represent a height of a feature and W may represent a width of a feature. Also, B represents the number of features having a size of (C, H, W). Each of C, H, W and B may be 0 or an integer greater than 0.

A feature group indicates a group configured with at least one feature.

When each of features configuring a feature group has the same scale, a corresponding feature group may be defined as a single-scale (or single-resolution) feature group. In an example, a single-scale feature group may be configured with features that all of the number of channels, a height and a width are the same such as p1=(C, H, W), p2=(C, H, W), p3=(C, H, W), etc.

When at least one of the number of channels, a height or a width of each feature configuring a feature group is different, a corresponding feature group may be defined as a multi-scale (or multi-resolution) feature group. In an example, features that the number of channels is the same, but a width and a height are different such as p1=(C, H, W), p2=(C, 2H, 2W), p3=(C, 4H, 4W), etc. or p1=(C, H, W), p2=(C, H′, W′), p3=(C, H″, W″), etc. may be defined as a multi-scale feature group. Alternatively, features that all of the number of channels, a width and a height are different such as p1=(C, H, W), p2=(C′, 2H, 2W), p3=(C″, 4H, 4W), etc. may be defined as a multi-scale feature group.

A single-scale feature group may be considered the same as one multi-channel feature. In an example, a single-scale feature group configured with N (C, H, W)-sized features may be considered as a (N×C, H, W)-sized multi-channel feature. Considering it, in the following embodiments, a feature of a specific size should be understood to mean a single-scale feature group as well as a single feature included in a feature group.

Hereinafter, embodiments according to the present disclosure will be described in detail.

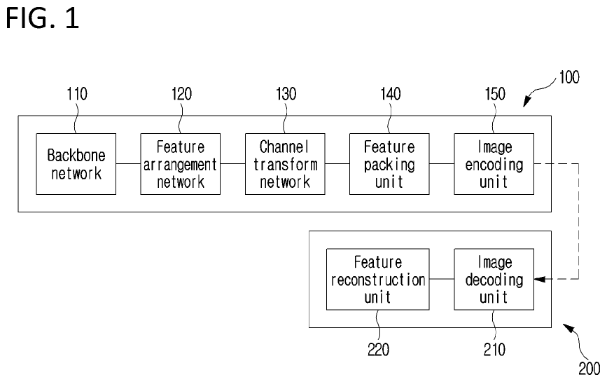

FIG. 1 represents a block diagram of a machine vision network for inputting an image and/or a video.

In an example shown in FIG. 1, a machine vision network may include a feature encoding device 100 and a feature decoding device 200.

A feature encoding device 100 may include at least one of a backbone network 110 which extracts a multi-scale feature group from an input image and/or video, a feature arrangement network 120 which performs feature arrangement on an extracted multi-scale feature group, a channel transform network 130 which performs channel transform for a single-scale feature group (or a multi-channel feature), a feature packing unit 140 which packs a feature group (or a feature) where channel transform is performed to a plane image and an image encoding unit 150 which encodes a plane image.

Meanwhile, some of networks configuring a feature encoding device 100 may be implemented based on remote computing such as a cloud computer.

A feature decoding device 200 may include at least one of an image decoding unit 210 which decodes a plane image received from a feature encoding device and a feature reconstruction unit 220 which reconstructs a feature or a multi-scale feature group based on a decoded image.

A reconstructed multi-scale feature group may be input to a mission network to perform a task related to machine vision.

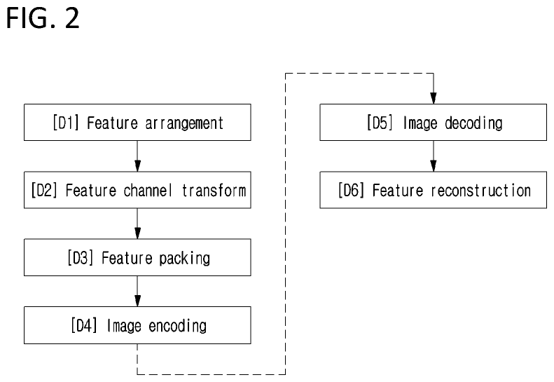

FIG. 2 is a flow chart representing a multi-scale feature encoding/decoding method according to an embodiment of the present disclosure.

In reference to an example shown in FIG. 2, a multi-scale feature encoding method includes [D1] a feature arrangement step, [D2] a feature channel transform step, [D3] a feature packing step and [D4] an image encoding step, which may be performed by a feature encoding device 100 shown in FIG. 1. Meanwhile, a multi-scale feature decoding method includes [D5] an image decoding step and [D6] a feature reconstruction step, which may be performed by a feature decoding device 200 shown in FIG. 1. Hereinafter, each step will be described in detail.

### [D1] Feature Arrangement Step

A plurality of features may be extracted from an image and extracted features may be adjusted to the same scale (or resolution) and arranged.

Specifically, a multi-scale feature group may be transformed into a single-scale feature group, i.e., a multi-channel feature, by adjusting a scale (a resolution) for features in a multi-scale feature group.

Meanwhile, at least one of features in a multi-scale feature group may be modified through a neural network. Here, a neural network may be configured with at least one layer of a pooling, fully-connected, convolution or activation function layer. In other words, a modified feature may be acquired by inputting a feature to at least one layer of a pooling, fully-connected, convolution or activation function layer. Alternatively, the neural network may be configured in the form of a residual signal block (res-block) or an attention block in which at least one of the enumerated components is combined.

Features may be divided into higher/lower levels according to the number of channels, a size or the amount of data. In an example, the highest level represents a feature with the smallest number of channels or the smallest size or the smallest amount of data and the lowest level represents a feature with the largest number of channels or the largest size or the largest amount of data. In an example, when a multi-scale feature group is configured with p1=(C, H, W), p2=(C, 2H, 2W), p3=(C, 4H, 4W) and p4=(C, 8H, 8W), feature p(N+1) may be considered as a lower level of feature pN and feature pN may be considered as a higher level of feature p(N+1).

Meanwhile, transform may not be applied to a specific feature in a multi-scale feature group (e.g., the highest level feature and/or the lowest level feature) and transform may be applied only to the remaining features.

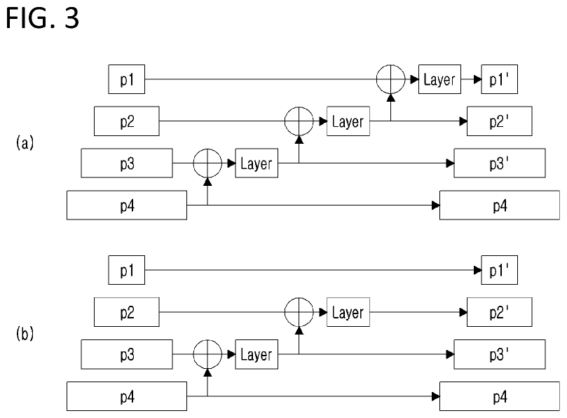

FIG. 3 shows an example of a neural network configuration in a bottom-up method in which a higher level feature is modified to include a lower level feature.

As in an example shown in FIG. 3, a neural network may be configured so that a higher level feature includes a lower level feature.

A modified higher level feature may be acquired by fusing a lower level feature with a higher level feature. Here, fusion may be to downscale a lower level feature according to a higher level feature and concatenate a downscaled lower level feature with a higher level feature or add a downscaled lower level feature to a higher level feature. In this case, concatenation may be to add channels of a downscaled lower level feature to channels of a higher level feature.

In an example, as in an example shown in FIG. 3(a), modification of feature p3 may be performed by fusing feature p4, a lower level of feature p3. In addition, modification of feature p2 may be performed by fusing feature p3 (specifically, modified feature p3), a lower level of feature p2. In addition, modification of feature p1 may be performed by fusing feature p2 (specifically, modified feature p2), a lower level of feature p1.

After fusing lower level feature p(N+1) to higher level feature pN, at least one of a pooling, fully-connected, convolution or activation function layer may be used to output modified higher level feature pN′.

Alternatively, a neural network may be configured so that some features are not modified. Here, a non-modified feature may be at least one of the highest feature and/or the lowest feature. In an example, in FIG. 3(a), it was illustrated that the lowest feature p4 is output without modification, and in FIG. 3(b), it was illustrated that the highest feature p1 and the lowest feature p4 are output without modification.

In another example, a neural network may be configured so that a lower level feature includes a higher level feature.

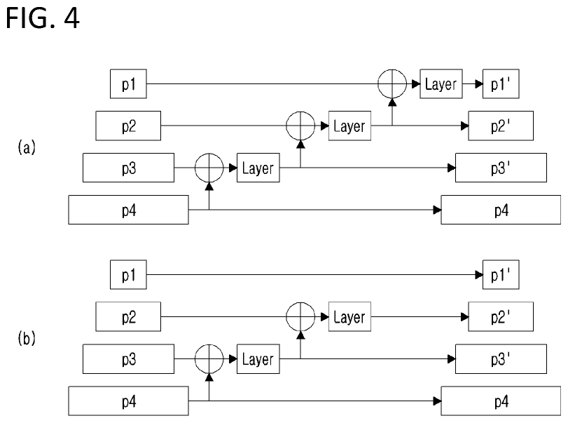

FIG. 4 shows an example of a neural network configuration in a top-down method in which a lower level feature is modified to include a higher level feature.

A modified lower level feature may be acquired by fusing a higher level feature with a lower level feature. Here, fusion may be to upscale a higher level feature according to a lower level feature and concatenate an upscaled higher level feature with a lower level feature or add an upscaled higher level feature to a lower level feature. In this case, concatenation may be to add channels of an upscaled higher level feature to channels of a lower level feature.

In an example, as in an example shown in FIG. 4(a), modification of feature p2 may be performed by fusing feature p1, a higher level of feature p2. In addition, modification of feature p3 may be performed by fusing feature p2 (specifically, modified feature p2), a higher level of feature p3, with feature p3. In addition, modification of feature p4 may be performed by fusing feature p3 (specifically, modified feature p3), a higher level of feature p4, with feature p4.

After adding higher level feature p(N−1) to lower level feature pN, at least one of a pooling, fully-connected, convolution or activation function layer may be used to output modified lower level feature pN′.

Alternatively, a neural network may be configured so that some features are not modified. Here, a non-modified feature may be at least one of the highest feature and/or the lowest feature. In an example, in FIG. 4(a), it was illustrated that the highest feature p1 is output without modification, and in FIG. 4(b), it was illustrated that the highest feature p1 and the lowest feature p4 are output without modification.

A neural network may be configured to learn a residual for a feature.

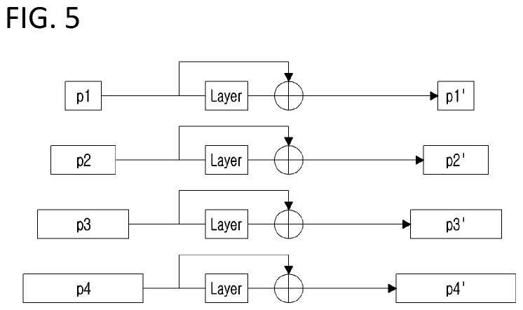

FIG. 5 shows a configuration example of a neural network which learns a residual for a feature.

What is output when feature pN is input to a layer may be configured as a prediction value for a feature. Then, difference value pN′ of a feature is generated by differentiating a prediction value of a feature from original feature pN, which may be configured as a modified feature.

Here, a layer may be configured with at least one of a pooling, fully-connected, convolution or activation function layer.

A feature to be scaled may be an original feature or a modified feature according to a configuration of a neural network.

A resolution of features in a multi-scale feature group may be different. Specifically, each of features may be different in at least one of the number of channels, a width or a height. When a resolution between features is different, features may be adjusted and arranged according to a reference resolution. Here, a predefined resolution may be a resolution of a feature with the smallest amount of data, a feature with the largest amount of data or a feature with an intermediate amount of data.

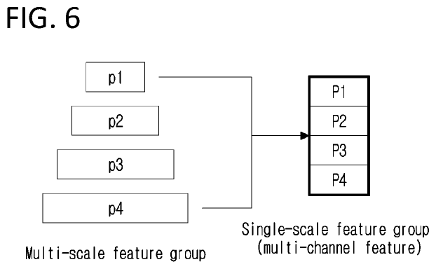

FIG. 6 represents an example in which features are arranged when a feature with the smallest resolution is configured as a reference resolution.

When a multi-scale feature group is configured with p1=(C, H, W), p2=(C, 2H, 2W), p3=(C, 4H, 4W) and p4=(C, 8H, 8W), features p2 to p4 may be downscaled to the same size as feature p1 based on feature p1 having the smallest amount of data.

Scaled features may be merged (or concatenated) into one. In an example, a single-scale feature group may be derived by arranging p1 and modified features p2 to p4 adjusted to a resolution of p1 in a size of (4C, H, W).

Contrary to a shown example, when a multi-scale feature group is configured with p1=(C, H, W), p2=(C, 2H, 2W), p3=(C, 4H, 4W) and p4=(C, 8H, 8 W), features p1 to p3 may be upscaled to the same size as feature p1 based on feature p4 having the largest amount of data.

Scaled features may be combined into one. In an example, a single-scale feature group may be derived by arranging p4 and modified features p1 to p3 adjusted to a resolution of p4 in a size of (4C, 8H, 8W).

Alternatively, when a multi-scale feature group is configured with p1=(C, H, W), p2=(C, 2H, 2W), p3=(C, 4H, 4W), and p4=(C, 8H, 8W), scale of features p1, p3 and p4 may be adjusted based on feature p2 having an intermediate amount of data. Specifically, feature p1 may be upscaled to the same size as feature p2 and features p3 and p4 may be downscaled to the same size as feature p2.

Scaled features may be combined into one. In an example, p2 and modified features p1, p3, and p4 adjusted to a resolution of p2 may be arranged in a size of (4C, 2H, 2W).

Features may be arranged by configuring a plurality of reference resolutions. In an example, a first downscale feature group for features belonging to a first group may be derived by applying a first reference resolution to features belonging to a first group among a plurality of features. In addition, a second downscale feature group for features belonging to a second group may be derived by applying a second reference resolution to features belonging to a second group among a plurality of features.

### [D2] Feature Channel Transform Step

At least one of channel increase, channel decrease or channel maintenance may be applied to a feature group or a feature configured with multiple channels. At least one of channel increase, channel decrease or channel maintenance may be applied to a single-scale feature group derived by modifying a multi-scale feature group. Alternatively, at least one of channel increase, channel decrease or channel maintenance may be applied to each feature in a single-scale feature group.

Hereinafter, it is assumed that the number of channels for a feature in a size of (C, H, W) is adjusted, but of course, the following embodiments may be also equally applied to a single-scale feature group in a size of (N×C, H, W).

A size of a feature may be expressed as (C, H, W). Here, C represents any positive integer and a multi-channel feature represents that a value of C is greater than 1.

In order to adjust the number of channels of a feature, inter-channel readjustment may be performed. A network for inter-channel readjustment may be configured with at least one layer of a pooling, fully-connected, convolution, or activation function layer.

For inter-channel readjustment, at least one representative value may be extracted from a feature.

Specifically, a representative value for each of channels configuring a feature may be extracted.

A representative value of a channel may be at least one of an average value, a maximum value, a minimum value, a central value or a mode value of pixels.

Alternatively, a representative value of a channel may be extracted through at least one convolution layer.

A feature in a size of (C, H, W) may be expressed as a size of (C, 1, 1) by extracting a representative value of each of channels.

Alternatively, when a plurality of representative values are extracted per channel, a feature in a size of (C, H, W) may be expressed as a size of (N×C, 1, 1). Here, N represents the number of representative values and may be a natural number such as 2, 3, 4.

A representative value of each channel may be adjusted through at least one fully-connected layer.

In an example, a representative value of a feature in a size of (C, 1, 1) adjusted by a representative value may be adjusted through at least one fully-connected layer and adjusted to a feature in a size of (C′, 1, 1).

In an example, a representative value of a feature in a size of (2C, 1, 1) adjusted by two representative values may be adjusted through at least one fully-connected layer and adjusted to a feature in a size of (C′, 1, 1).

Here, C′ may be the same value as C or may be a different value from C.

A feature scaled based on a representative value may be readjusted based on a representative value. In this case, readjustment may be performed by applying at least one four arithmetic operations to a representative value.

In an example, after adjusting a feature in a size of (C, H, W) to a feature in a size of (C, 1, 1), a feature may be readjusted by multiplication per each channel.

Alternatively, after adjusting a feature in a size of (C, H, W) to a feature in a size of (C, 1, 1), a feature may be readjusted by a sum per each channel. Alternatively, after adjusting a feature in a size of (C, H, W) to a feature in a size of (C, 1, 1), a feature may be readjusted by a difference per each channel.

Feature channel transform may be performed for each of features in a feature group or may be performed for a feature group. In this case, a feature or a feature group may be readjusted by a representative value. Feature channel transform may be performed by using a feature channel

transform network. Here, a feature channel transform network may be configured with at least one layer of a pooling, fully-connected, convolution or activation function layer.

In an example, a feature in a size of (C, H, W) may be transformed into a size of (C′, H, W) by at least one convolution layer. In this case, as C′ is a positive integer, it may be the same value as C or a different value from C. Preferably, C′ may have a value smaller than C.

According to the above-described embodiments, a multi-scale feature group may be transformed into a single-scale feature group through a feature arrangement step (D1). Hereinafter, a readjusted feature group may be output by applying a channel transform step (D2) to a single-scale feature group.

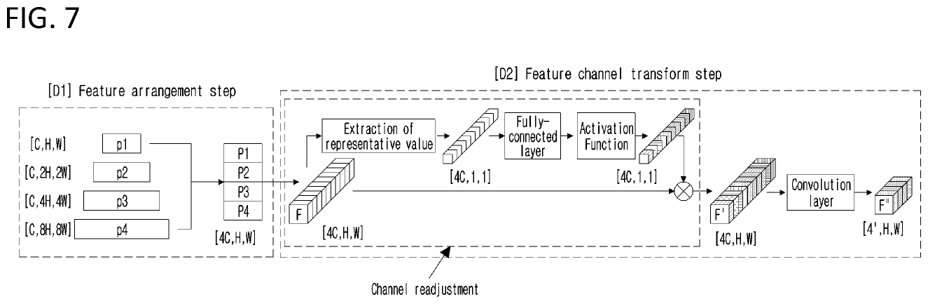

FIG. 7 shows an example in which a readjusted feature group is output through a feature arrangement step and a feature channel transform step.

In an example, when a multi-scale feature group is configured with p1=(C, H, W), p2=(C, 2H, 2W), p3=(C, 4H, 4W), and p4=(C, 8H, 8W), a multi-scale feature group may be transformed into single-scale feature group F in a size of (4C, H, W). Hereinafter, by performing channel transform including channel readjustment for single-scale feature group F, single-scale feature group F may be transformed into feature group F″ in a size of (C′, H, W).

Meanwhile, in performing channel transform, a channel readjustment process may be omitted.

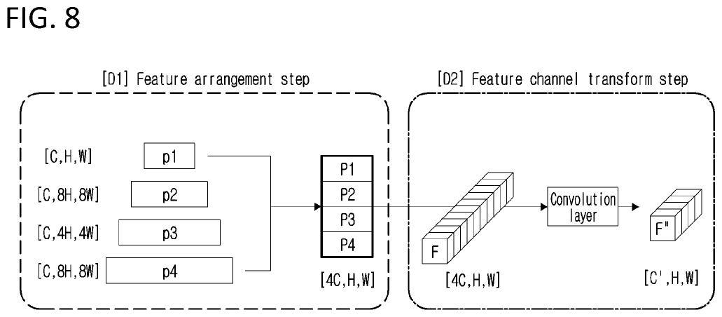

FIG. 8 illustrates a channel transform step in which a channel readjustment process is omitted.

In performing channel transform, a degree of channel transform may be adjusted by considering a compression rate.

In an example, for low-quality compression (i.e., a low bit rate), a degree of channel reduction should be increased to minimize a generated bit rate. On the other hand, for high-quality compression (i.e., a high bit rate), a degree of channel reduction may be decreased to reduce the amount of lost information. Here, a large degree of channel reduction means that a difference between 4C, the number of channels of an input feature (or feature group), and C′, the number of channels of a feature (or a feature group) output through channel transform, is relatively large and a small degree of channel reduction means that the difference is relatively small.

Alternatively, for low-quality compression (i.e., a low bit rate), a degree of channel increase should be decreased to minimize a generated bit rate. On the other hand, for high-quality compression (i.e., a high bit rate), a degree of channel increase may be increased to reduce the amount of lost information. Here, a large degree of channel increase means that a difference between 4C, the number of channels of an input feature (or feature group), and C′, the number of channels of a feature (or a feature group) output through channel transform, is relatively large and a small degree of channel increase means that the difference is relatively small.

Considering the correlation, a compression parameter may be adaptively determined according to a degree of channel transform. Here, a compression parameter may include a quantization parameter.

In an example, a quantization parameter may be adaptively determined according to a degree of channel reduction by configuring an optimized function between a degree of channel reduction and a quantization parameter (QP) of a compression codec used to compress a channel.

In an example, a quantization parameter may be adaptively determined according to a degree of channel increase by configuring an optimized function between a degree of channel increase and a quantization parameter (QP) of a compression codec used to compress a channel.

In an example, a quantization parameter may be adaptively determined according to a degree of channel increase by configuring an optimized function between a quantization parameter (QP) of a compression codec used to compress a channel and channel maintenance.

In other words, the number of optimized channels and a quantization parameter may be derived based on an optimization function.

In performing channel transform, the number of adjusted channels may be adaptively determined based on importance of a channel.

In an example, in performing inter-channel readjustment, the number of channels may be reduced by removing a channel with low importance after determining importance for each channel through an activation function. Here, an activation function may include at least one of sigmoid, relu, prelu, or leaky-relu.

When the number of channels is adjusted, information related to the number of channels may be transmitted as additional information (e.g., metadata) in order to reconstruct a feature (or a feature group) to an original size. The additional information may include at least one of information representing the number of adjusted channels, difference information between the number of original channels and the number of adjusted channels or information representing the number of original channels.

A channel transform network for channel transform may be learned to list channels according to importance of a machine vision mission. Accordingly, a feature output through a channel transform network may be different in at least one of the arrangement of channels or the number of channels compared to an input feature.

By listing channels according to mission importance, the number of feature channels to be compressed may be adaptively determined according to a required compression rate and/or machine vision mission performance.

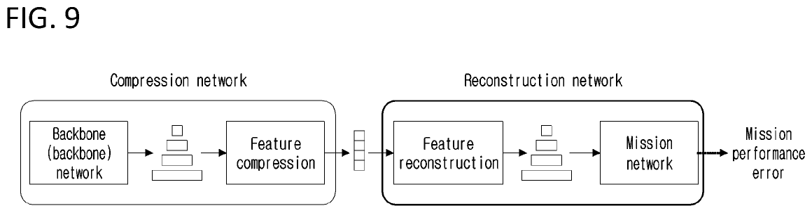

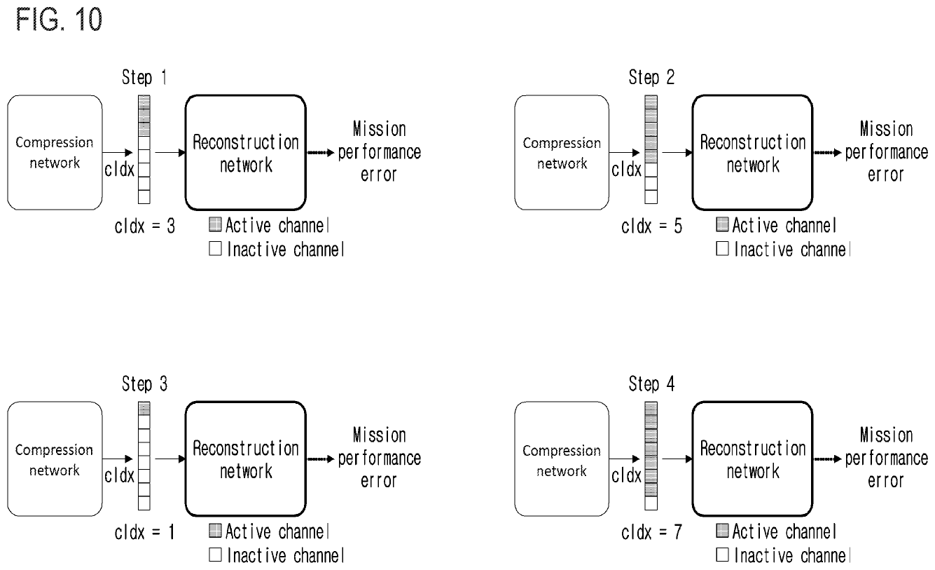

FIG. 9 and FIG. 10 are a diagram for describing a learning process of a channel transform network for listing channels according to mission importance.

In FIG. 9, a compression network represents an operation on a side which encodes a multi-scale feature group (i.e., a feature encoding device 100) and a reconstruction network represents an operation on a side which decodes a multi-scale feature group (i.e., a feature decoding device 100).

As in an example shown in FIG. 9, a channel transform network may perform learning based on a mission performance error (task loss). However, as in an example shown in FIG. 9, when learning is performed only with a mission error, there is a problem that importance between channels may not be accurately understood.

Accordingly, as in an example shown in FIG. 10, a channel transform network may be learned by selecting the number of channels of a feature participating in learning together with a mission performance error.

In an example shown in FIG. 10, cldx represents the number of selected channels (or an index of the number of channels). For convenience of a description, it is assumed that the number of channels output from a compression network is 8.

A feature output from a compression network may select at least one of the total channels. In this case, the selection may be based on at least one of random, predetermined rule or distribution selection.

In Step 1 shown in FIG. 10, it was illustrated that cldx is 3. When cldx is 3, only a first channel to a third channel of a feature are activated. In a reconstruction network, a mission is performed by using only an activated channel. A channel transform network learns an arrangement combination that a mission error is minimized while changing arrangement order from a first channel to a third channel.

In Step 2 shown in FIG. 10, it was illustrated that cldx is 5. If cldx is 5, only a first channel to a fifth channel of a feature are activated. In a reconstruction network, a mission is performed by using only an activated channel. A channel transform network learns an arrangement combination that a mission error is minimized while changing arrangement order from a first channel to a fifth channel.

In Step 3, it was illustrated that cldx is configured as 1 and in Step 4, it was illustrated that cldx is configured as 7.

As in an example shown in FIG. 10, importance between channels may be learned while adjusting the number of input channels step by step.

Meanwhile, in an example shown in FIG. 10, for a first channel, since it participates in learning at every step, it may be a channel which has a big influence on a mission performance error. On the other hand, for a last channel, since its frequency of participation in learning is relatively low, it may be a channel which does not have a big influence on a mission performance error.

Meanwhile, learning may be performed by further using at least one of mean square error (MSE) and distortion as well as a mission error. Alternatively, a process of performing learning may be simplified by using at least one of MSE or distortion, instead of a mission error.

### [D3] Feature Packing Step

Encoding/decoding of a feature may be performed based on at least one of the existing image compression codec (e.g., AVC, HEVC or VVC, etc.) or a neural network-based image compression codec. In order to encode/decode a feature based on an image compression codec, a feature may be transformed into a form suitable for image compression.

In an example, a multi-channel feature in a size of (C, H, W) may be transformed into a single-channel plane image in a size of nH′×mW′. Here, n×m may have the same value as C, the number of channels. Alternatively, when only some of all channels are selectively encoded/decoded, n×m may have a value smaller than C, the number of channels.

H′ and W′ may be configured as the same value as H and W, respectively. In other words, according to the number of packed channels, each of channels may be reduced to generate a 2D frame in the same size as an original channel.

Alternatively, each of H′ and W′ may be configured differently from H and W. In an example, when channels are arranged in N columns and M rows, W′ may be configured as a size of N×W and H′ may be configured as a size of M×H.

A plane image transformed from a multi-channel feature may be defined as a feature map.

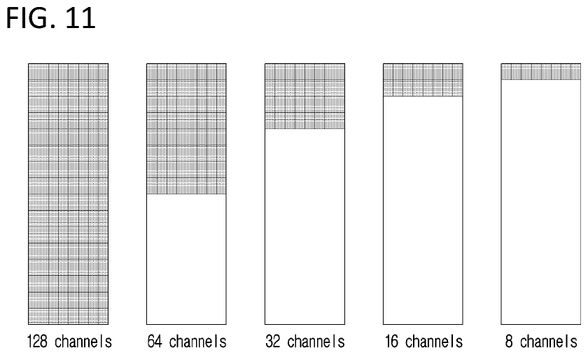

FIG. 11 represents an output example of a plane image acquired from a feature configured with a plurality of channels, i.e., a feature map.

A feature that channels are arranged according to importance may be output as in FIG. 11. When a feature has a size of (128×40×24), each channel has a size of 40×24. A feature map as in an example shown in FIG. 11 may be acquired by packing it to one frame according to channel order. In an example shown in FIG. 11, it was assumed that channels are packed according to raster scan order.

When channels are arranged according to importance, as a channel has a lower priority, a degree of influence on a mission error is smaller. Even in an example shown in FIG. 11, the later packing order is, the smaller the amount of content included is.

According to the characteristic, by adjusting the number of channels, mission performance and a compression rate may be adaptively adjusted.

Specifically, when the number of selected channels is large, machine vision mission performance is improved, but a compression rate is lowered. On the other hand, when the number of selected channels is large, a compression rate is increased, but machine vision mission performance is degraded.

Accordingly, the number of encoded/decoded channels may be selected so that a relationship between the number of selected channels and machine vision mission performance is optimized.

Meanwhile, at least one of information on the number of selected channels or size information of each channel may be additionally encoded/decoded.

A multi-channel feature in a size of (C, H, W) may be transformed into a multi-channel (C′) video in a size of nH′×mW′, i.e., a plurality of feature maps. Here, C′×n×m may have the same value as C, the number of channels. Alternatively, when only some of all channels are selectively encoded/decoded, C′×n×m may have a value smaller than C, the number of channels.

Here, a transformed video may be a black (monocrome) or color video. In an example, a multi-channel feature may be transformed into a three-channel video such as YUV, YCbCr or YUV.

Meanwhile, in order to improve image compression efficiency, instead of sequentially packing channels, arrangement order of channels may be adaptively determined according to an inter-channel correlation. In this case, an inter-channel correlation may be determined based on at least one of a mean squared error (MSE) between channels, an average value of a channel or a central value of a channel.

Rearrangement may include at least one of spatial rearrangement or temporal rearrangement.

When a feature is transformed into a form suitable for image compression, information about transform may be additionally encoded/decoded. Transform information may include at least one of normalization information or information on arrangement order of channels.

In an example, when a normalization process is accompanied to transform a feature into an image form, information on a normalization process may be encoded/decoded. When maximum and/or minimum normalization is performed, the normalization information may include the maximum value and/or the minimum value. Alternatively, when average and/or standard deviation normalization is performed, the normalization information may include an average value and/or a standard deviation value.

In an example, when packing order of channels is adaptively determined, information on arrangement order of channels may be encoded/decoded.

### [D4] Image Encoding Step/[D5] Image Decoding Step

A feature or an image output through at least one of steps D1 to D3 may be encoded/decoded. Specifically, a feature encoding device may encode a feature or an image and a feature decoding device may decode a compressed feature or image.

When a multi-channel feature is transformed into an image, tile-based

encoding/decoding may be performed to reduce compression inefficiency at an inter-channel boundary in an image.

In an example, each of channels packed in an image may be defined as one tile. In other words, when a multi-channel feature is transformed into a frame in a size of nH′×nW′, each tile may be defined as a size of H′×W′.

Alternatively, a plurality of channels may be defined as one tile. In this case, each of tiles may have a uniform size.

Alternatively, a size of a tile may be configured differently according to inter-channel importance. In an example, the number of channels included by a tile including a channel of high importance may have a smaller value than the number of channels included by a tile including a channel of low importance.

When tile-based encoding/decoding is supported, a quantization degree may be configured differently according to a region of interest. For example, a quantization parameter for a region where an important feature (e.g., a channel of high importance) is arranged may have a lower value than a quantization parameter for a region where an insignificant feature (e.g., a channel of low importance) is arranged. Here, a region may include at least one tile.

Meanwhile, information on a region where a quantization parameter is configured may be additionally encoded/decoded. The information may include at least one of the number of regions having a different quantization parameter, a size of each region or a quantization parameter of each region. Meanwhile, information on a size of a region may include at least one of the number of tiles in a region, a coordinate of a region or an index of a tile included in a region.

Encoding/decoding of an image may be performed in a unit of a sample, a line, a block or a sub-frame. In this case, based on at least one of a shape, a size or a dimension of an input feature, an encoding/decoding unit of an image may be adaptively selected. Here, a decoding unit may be the same as an encoding unit, and an encoding unit may represent a unit in which at least one of prediction, transform, quantization, reconstruction or an in-loop filter is performed.

Alternatively, an encoding unit may be adaptively determined according to a configuration of a feature. Specifically, when a feature is configured with multiple channels and channels are packed in a frame according to correlation between channels, an encoding unit may be defined based on correlation.

In an example, if channels are arranged by a specific average value, channels having a similar average value may be configured in one encoding unit.

Alternatively, if channels are arranged based on a degree of similarity between channels, an encoding unit may be configured in a bundle of similar channels.

Information on an encoding unit of an image may be encoded and signaled. In an example, when an image is encoded/decoded in a unit of a block, at least one of a partition shape of blocks, a size of a block or a shape of a block may be encoded/decoded.

In an example, when an image is encoded/decoded in a unit of a line, at least one of a length of a line, the number of lines or a shape of a line may be encoded/decoded.

In an example, when an image is encoded/decoded in a unit of a sub-frame, at least one of a partition shape of frames, a size of a frame, a shape of a frame or the number of frames may be encoded/decoded.

Meanwhile, when a feature is encoded/decoded, encoding/decoding through prediction may be supported. Prediction may be performed by at least one of spatial prediction, temporal prediction or inter-channel prediction. According to a characteristic of a feature, a prediction method may be adaptively selected.

Spatial prediction for an encoding unit may be performed based on a prediction value of a surrounding sample or a previously encoded/decoded surrounding sample. In spatial prediction, a group of surrounding samples or at least one sample in the group may be used.

When prediction for an encoding unit is performed from a previously encoded/decoded surrounding sample, at least one of directional prediction, template prediction, dictionary prediction or matrix product prediction may be used.

In an example, when directional prediction is performed, a prediction sample within a current encoding unit may be derived by copying a previously encoded/decoded surrounding sample in a specific direction or by interpolating surrounding samples.

In an example, when template prediction is performed, a prediction block in a current encoding unit may be derived by searching for a template most similar to a current encoding unit based on previously encoded/decoded surrounding samples.

In an example, when dictionary prediction is performed, a previously encoded/decoded surrounding sample or a prediction block in an encoding unit may be stored as a dictionary in a separate memory and a prediction block or a prediction sample for a current encoding unit may be derived from a dictionary stored in a memory. In an example, when a plurality of prediction values or a plurality of prediction blocks are stored in a memory, one of a plurality of candidates may be derived as a prediction sample or a prediction block in a current encoding unit. To this end, information indicating one of a plurality of candidates (e.g., an index) may be encoded and signaled.

In an example, when matrix product prediction is performed, a prediction sample for a current encoding unit may be acquired based on product between a previously encoded/decoded surrounding sample and a matrix.

Temporal prediction refers to acquisition of a prediction value for an encoding unit from a previous and subsequent frame having different time from a current frame (i.e., a frame having different output order).

Inter-channel prediction refers to acquisition of a prediction value fora current channel from a previously encoded/decoded channel when a feature is configured with multiple channels.

When prediction-based encoding/decoding is performed, a residual signal may be generated based on a difference between an original signal and a prediction signal and a residual signal may be encoded/decoded. Specifically, a residual signal may be acquired by differentiating a prediction signal acquired by at least one of spatial prediction, temporal prediction or inter-channel prediction from an original signal.

Meanwhile, in order to reconstruct a feature from an encoded image, information on a feature map related to a feature may be additionally entropy-encoded/decoded. In an example, together with image compression data, at least one information on a feature map may be encoded as metadata and signaled.

Information on a feature map may include at least one of matters listed below.
At least one of the maximum value, the minimum value, an average value, a mode value or a standard deviation of a sample in a feature map
At least one of the maximum value, the minimum value, an average value, a mode value or a standard deviation of a sample for each of channels in a feature map
An index identifying each of channels in a feature map
An index for a region of interest in a feature map
An index indicating a channel of interest in a feature map
A parameter related to a channel transform degree and compression degree function
The number of channels included in a feature map
Size information of a feature map
Size information (W×H) of each channel in a feature map
Importance of each channel in a feature map
A quantization parameter for channels in a feature map

When any one of information on a feature map listed above is entropy-encoded/decoded, one of the following listed methods may be used.
A truncated rice binarization method
A K-th order exp-golomb binarization method
A fixed length binarization method
A unary binarization method
A truncated unary binarization method
A truncated binary binarization method

Entropy encoding/decoding for binary information acquired by binarizing information on a feature map may be performed based on one of the following listed matters.
Context-adaptive binary arithmetic coding (CABAC)
Context-adaptive variable length coding (CAVLC)
By-pass coding

An entropy encoding/decoding method may be adaptively determined by using at least one encoding information of a size/a shape of a feature or encoding information of a feature at a surrounding position.

### [D6] Feature Reconstruction Step

After decoding a plane image that features are packed, a feature, specifically, a feature group may be reconstructed from a decoded image.

Reconstruction of a feature may have the same scale (or resolution) as an original feature. In other words, a reconstructed feature may be expressed as (H, W), (C, H, W), or (B, C, H, W). Here, B represents the number of features having a size of (C, H, W) and may be an integer greater than or equal to 0.

A reconstructed feature group may be a single-scale feature group having the same scale (or resolution). In an example, a reconstructed feature group may be configured with features that the number of channels, a height and a width are the same, such as p1=(C, H, W), p2=(C, H, W), and p3=(C, H, W).

Alternatively, a reconstructed feature group may be a multi-scale feature group having a different scale (or resolution). In an example, a reconstructed feature group may be configured with features that the number of channels is the same as C, but a height and a width are different, such as p1=(C, H, W), p2=(C, 2H, 2W) and p3=(C, 4H, 4W), etc. or p1=(C, H, W) , p2=(C, H′, W′) and p3=(C, H″, W″), etc. Alternatively, a reconstructed feature group may be configured with features that the number of channels, a height and a width are different, such as p1=(C, H, W), p2=(C′, 2H, 2W), and p3=(C″, 4H, 4W). When a plane image is decoded, a multi-channel feature may be acquired from

a decoded plane image. In other words, a multi-channel feature may be acquired by considering packing order between channels in a plane image.

Subsequently, each of features in a multi-scale feature group may be reconstructed from an acquired multi-channel feature.

Meanwhile, in order to reconstruct a feature, inverse transform for transform applied in a feature arrangement step, a feature channel transform step, a feature packing step or a feature compression step may be performed. The inverse transform may be performed based on at least one of upscaling, downscaling, a convolution layer, a fully connected layer or an activation function.

In an example, when a size of a feature needs to be reconstructed to its original size, at least one of upscaling, downscaling and a convolution layer may be used. For example, it is assumed that a size of a feature extracted from a decoded image is (C, H′, W′) and a size of an original feature is (C, H, W). In this case, for H′<H and W′<W, a feature may be reconstructed based on at least one of upscaling or a convolution layer. Here, upscaling may be performed based on at least one of linear interpolation, latest value interpolation or bi-cubic interpolation. In addition, a transposed convolution layer instead of a convolution layer may be used.

Alternatively, for H′>H, W′>W, a feature may be reconstructed based on at least one of downscaling or a convolution layer. Here, downscaling may be performed based on at least one of linear interpolation, latest value interpolation or bi-cubic interpolation. In addition, a transposed convolution layer instead of a convolution layer may be used.

In an example, when the number of channels of a feature needs to be reconstructed to the original number of channels, at least one of a convolution layer, a fully connected layer or an activation function may be used.

For example, it is assumed that a resolution of a feature extracted from a decoded image is (′C, H, W) and a resolution of an original feature is (C, H, W). In this case, a feature that the number of channels is C′ may be reconstructed to a feature that the number of channels is C through a convolution layer. In addition, a transposed convolution layer instead of a convolution layer may be used. The number of channels may be reconstructed by inputting a result output from a convolution layer to an activation function.

In Step [D1], when a multi-scale feature group is transformed by a bottom-up method or by a top-down method, each feature in a multi-scale feature group may be reconstructed based on a residual reconstruction method.

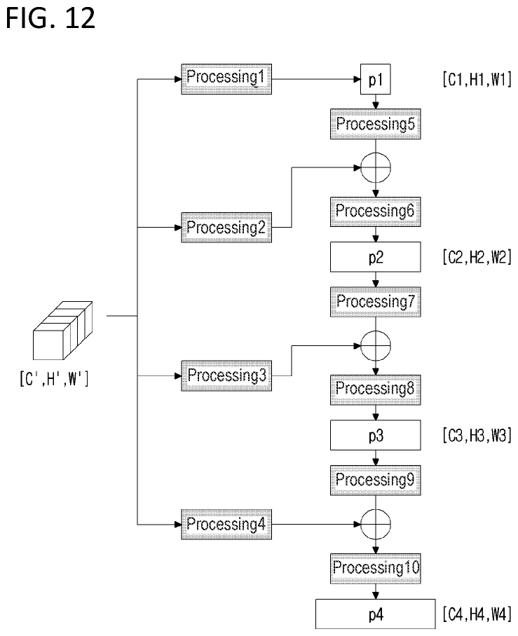

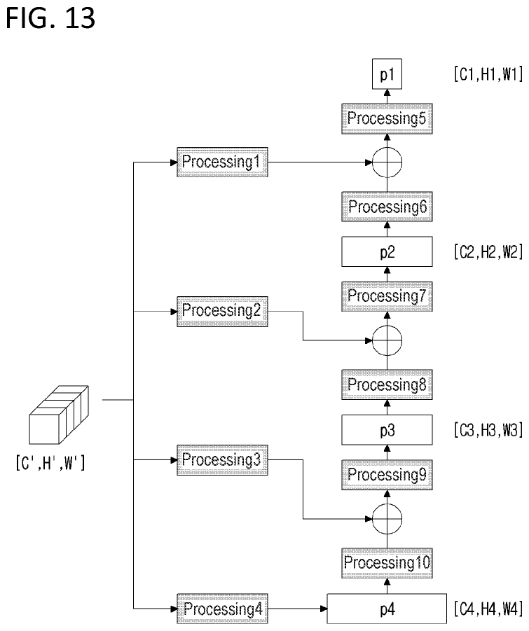

FIG. 12 and FIG. 13 show an example of reconstructing each feature in a multi-scale feature group.

FIG. 12 represents a top-down residual reconstruction method and FIG. 13 represents a bottom-up residual reconstruction method.

For convenience of a description, it is assumed that N features included in a multi-scale feature group are reconstructed from a multi-channel feature in a size of (C′, H′, W′). As N is a positive integer, in this embodiment, it is assumed that N is 4.

From a decoded image, a multi-channel feature (C′, H′, W′) may be derived, and a derived multi-channel feature may be distinguished by the number of features in a multi-scale feature group. Each of distinguished features may be input to a processing step corresponding to each.

Specifically, in an example shown in FIG. 12 and FIG. 13, ‘Processing M’ may include at least one of upscaling, downscaling, a convolution layer, a transposed convolution layer or an activation function according to a characteristic of a feature to be reconstructed. Here, a characteristic of a feature to be reconstructed may include at least one of a size or the number of channels of a feature to be reconstructed.

In an example, when each of features to be reconstructed has the same number of channels, but has a different size, each of Processing 1, Processing 2, Processing 3 and Processing 4 may be configured with at least one of upscaling, downscaling, a convolution layer, a transposed convolution layer or an activation function for modifying a size of an input feature.

In addition, when the number of channels of a distinguished feature is C′, while the number of channels of a feature to be reconstructed is C, each of Processing 1, Processing 2, Processing 3 and Processing 4 may include a process for transforming the number of channels from C′ to C.

Meanwhile, when at least one of the number of channels or a size of a feature is changed by at least one of a feature arrangement step, a feature channel transform step, a feature packing step and a feature encoding step, additional information for reconstructing it may be required. The additional information may be encoded as metadata and signaled, and in a reconstruction step, at least one of the number of channels or a size of a feature may be reconstructed by referring to the additional information.

In a top-down residual reconstruction method shown in FIG. 12, a lower level feature p(N+1) may be reconstructed by fusing a reconstructed higher level feature pN with a feature that a size or the number of channels is adjusted through Processing M. Specifically, a higher level feature may be upscaled according to a lower level feature, and an upscaled higher level feature may be fused with a lower level feature to reconstruct a lower level feature. Accordingly, in a top-down method, features may be reconstructed in order from the highest level to the lowest level.

On the other hand, in a bottom-up residual reconstruction method shown in FIG. 13, a higher level feature pN may be reconstructed by fusing a reconstructed lower level feature p(N+1) with a feature that a size or the number of channels is adjusted through Processing M. Specifically, a lower level feature may be downscaled according to a higher level feature, and a downscaled lower level feature may be fused with a higher level feature to reconstruct a higher level feature. Accordingly, in a bottom-up method, features may be reconstructed in order from the lowest level to the highest level.

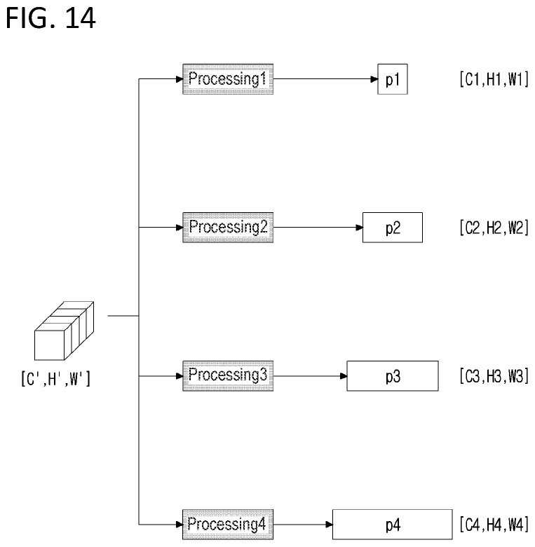

FIG. 14 represents another example of reconstructing a multi-scale feature group.

As in an example shown in FIG. 14, a multi-scale feature group may be reconstructed without using correlation between features. As in a shown example, 4 original features may be reconstructed from a multi-channel feature in a size of (C′, H′, W′). In this case, Processing M may include at least one of upscaling, downscaling, a convolution layer, a transposed convolution layer or an activation function according to a characteristic of a feature to be reconstructed. Here, a characteristic of a feature to be reconstructed may include at least one of a size or the number of channels of a feature to be reconstructed.

In an example, when each of features to be reconstructed has the same number of channels, but has a different size, each of Processing 1, Processing 2, Processing 3 and Processing 4 may be configured with at least one of upscaling, downscaling, a convolution layer, a transposed convolution layer or an activation function for modifying a size of an input feature.

In addition, when the number of channels of a distinguished feature is C′, while the number of channels of a feature to be reconstructed is C, each of Processing 1, Processing 2, Processing 3 and Processing 4 may include a process for transforming the number of channels from C′ to C.

Meanwhile, when at least one of the number of channels or a size of a feature is changed by at least one of a feature arrangement step, a feature channel transform step, a feature packing step and a feature encoding step, additional information for reconstructing it may be required. The additional information may be encoded as metadata and signaled, and in a reconstruction step, at least one of the number of channels or a size of a feature may be reconstructed by referring to the additional information.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application- specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. A multi-scale feature group encoding method comprising:
transforming the multi-scale feature group into a multi-channel feature;
adjusting a number of channels of the multi-channel feature;
acquiring a plane image based on a feature that the number of channels is adjusted; and
encoding the plane image.

2. The method according to claim 1, wherein transforming the multi-scale feature group into the multi-channel feature includes:
inputting features included in the multi-scale feature group to a transform network; and
transforming features output through the transform network according to a reference scale.

3. The method according to claim 2, wherein:
the transform network outputs the feature input to the transform network by transforming it based on a higher level feature or a lower level feature.

4. The method according to claim 1, wherein:
the feature that the number of channels is adjusted has a smaller number of channels than the multi-channel feature.

5. The method according to claim 4, wherein:
adjusting the number of channels of the multi-channel feature includes performing inter-channel readjustment for the multi-channel feature,
the inter-channel readjustment is performed based on a representative value of each channel configuring the multi-channel feature.

6. The method according to claim 5, wherein:
the representative value is derived based on at least one of an average value, a minimum value, a maximum value or a mode value of samples for a corresponding channel.

7. The method according to claim 5, wherein:
adjusting the number of channels of the multi-channel feature further includes adjusting arrangement order of each channel according to importance of each channel.

8. The method according to claim 7, wherein:
the plane image is acquired by packing each of channels of the feature that the number of channels is adjusted to a different space on a two-dimensional space.

9. The method according to claim 8, wherein:
the number of channels to be packed on the two-dimensional space is determined according to importance of each of the channels.

10. The method according to claim 7, wherein:
the plane image is partitioned into a plurality of tiles,
a boundary of the tile matches an inter-channel boundary.

11. The method according to claim 10, wherein:
a quantization parameter between the tiles is different.

12. The method according to claim 8, wherein:
a quantization parameter for each of the channels is adaptively determined according to importance of each of the channels.

13. A multi-scale feature group decoding method comprising:
decoding a plane image;
extracting a multi-channel feature from the decoded plane image; and
reconstructing the multi-scale feature group from the multi-channel feature.

14. The method according to claim 13, wherein reconstructing the multi-scale feature group comprising:
dividing the multi-channel feature into a plurality of features; and
reconstructing each of the divided features to an original resolution,
wherein reconstruction to the original resolution is performed based on at least one of upscaling, downscaling, a convolution layer, a fully-connected layer or an activation function.

15. The method according to claim 14, wherein:
a feature in the multi-scale feature group is reconstructed by fusing a pre-reconstructed lower level feature or a pre-reconstructed higher level feature with the feature reconstructed to the original resolution.

16. A multi-scale feature group encoding device comprising:
a feature arrangement network transforming the multi-scale feature group into a multi-channel feature;
a channel transform network adjusting a number of channels of the multi-channel feature;
a feature packing unit acquiring a plane image based on a feature that the number of channels is adjusted; and
an image encoding unit encoding the plane image.

17. A multi-scale feature group decoding device comprising:
an image decoding unit decoding a plane image; and
a feature reconstruction unit extracting a multi-channel feature from the decoded plane image and reconstructing the multi-scale feature group from the multi-channel feature.
